(19) United States
(12) Patent Application Publication
(10) Pub. No.: US 2010/0157377 A1
(43) Pub. Date: Jun. 24, 2010

(54) UV FLUORESCENCE ENCODED BACKGROUND IMAGES USING ADAPTIVE HALFTONING INTO DISJOINT SETS

(75) Inventors: Yonghui Zhao, Penfield, NY (US); Shen-ge Wang, Fairport, NY (US); Reiner Eschbach, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/337,686

(22) Filed: Dec. 18, 2008

(51) Int. Cl. G06K 15/00; G06K 9/00

(52) U.S. Cl. 358/3.28; 382/100; 358/3.06

(57) ABSTRACT

Systems and methods are described that facilitate generating a background image with a UV-fluorescent watermark for printing on a document. A binary watermark mask is generated to separate the background image into the UV-active and the UV-dull regions. Based on the assigned binary value of the watermark mask, each pixel is assigned a UV-active or UV-dull color using an adaptive halftoning technique, in order to generate a binary UV-active image and a binary UV-dull image. A binary watermarked background image is generated by combining the binary UV-active and UV-dull images, and is printed on a document. The UV-active and UV-dull colors have different UV intensities under UV light, but are indistinguishable under normal lighting conditions. In this manner, the background image is visible when exposed to visible light, and the UV-fluorescent watermark is visible when exposed to UV light.

### CROSS REFERENCE TO RELATED APPLICATIONS

Cross-reference is made to the following patents and applications, the entireties of which are herein incorporated by reference.

U.S. Publication No. US 2007/0264476 A1, published Nov. 15, 2007, entitled “SUBSTRATE FLUORESCENCE MASK FOR EMBEDDING INFORMATION IN PRINTED DOCUMENTS,” by Bala et al.;

U.S. Publication No. US 2007/0262579 A1, published Nov. 15, 2007, entitled “SUBSTRATE FLUORESCENCE PATTERN MASK FOR EMBEDDING INFORMATION IN PRINTED DOCUMENTS,” by Bala et al.;

U.S. Publication No. US 2008/0199785 A1, published Aug. 21, 2008, entitled “SUBSTRATE FLUORESCENCE MASK UTILIZING A MULTIPLE COLOR OVERLAY FOR EMBEDDING INFORMATION IN PRINTED DOCUMENTS,” by Bala et al.;

U.S. Pat. No. 5,070,413, issued Dec. 3, 1991, entitled “COLOR DIGITAL HALFTONING WITH VECTOR ERROR DIFFUSION,” by Sullivan et al.;

U.S. Pat. No. 5,621,546, issued Apr. 15, 1997, entitled “METHOD AND APPARATUS FOR VECTOR ERROR DIFFUSION WITH OUTPUT COLOR CONTROL,” by Klassen et al.;

U.S. Pat. No. 6,014,233, issued Jan. 11, 2000, entitled “ERROR DIFFUSION FOR COLOR IMAGES WITH SEMI-VECTOR QUANTIZATION,” by Fan et al.;

U.S. application Ser. No. 11/937,673, filed Nov. 9, 2007, entitled “FLUORESCENCE-BASED CORRELATION MARK FOR ENHANCED SECURITY IN PRINTED DOCUMENTS,” by Bala et al.;

U.S. application Ser. No. 11/754,733, filed May 29, 2007, entitled “METHODOLOGY FOR SUBSTRATE FLUORESCENT NON-OVERLAPPING DOT DESIGN PATTERNS FOR EMBEDDING INFORMATION IN PRINTED DOCUMENTS,” by Bala et al.; and

U.S. application Ser. No. 11/754,702, filed May 29, 2007, entitled “SUBSTRATE FLUORESCENT NON-OVERLAPPING DOT PATTERNS FOR EMBEDDING INFORMATION IN PRINTED DOCUMENTS,” by Bala et al.

### BACKGROUND

The subject application relates to anti-counterfeiting measures for paper documents. While the systems and methods described herein relate to anti-counterfeiting security techniques and the like, it will be appreciated that the described techniques may find application in other imaging systems, other security applications, etc.

In security applications, it is desirable to add information into the document that prevents or hinders alterations and counterfeiting. In classical scenarios, an ultraviolet (UV)-fluorescent background image is quite often used. In this case (and in security in general) it is important that the UV fluorescence image is independent of the front surface image, or at least only loosely correlated. Commonly this is achieved by using an independent “clear” UV-active ink (or multiple such inks) in separate print steps.

Attributes of background images include their “light” appearance. In other words, the image data is restricted to the upper part of the printer gamut (e.g., L or L* values in the upper portion of the 0-100 scale). This attribute is in part due to the constraint that the toner area coverage for at least one of the metamers should be noticeably below 100%. However, in many security applications, this restriction does not impact the actual usage scenario since the “security image” is desirably an unobtrusive part of the page and is thus chosen to be “light” since other information is to be superimposed thereon.

A UV-fluorescent signal can be generated within a conventional cyan-magenta-yellow-black (CMYK) printing system by metameric rendering on standard xerographic papers. In conventional UV-fluorescence technology, there are two assumptions. The first is that xerographic papers are fluorescent, which is commonly true since the specification for paper brightness is a simple measurement at 457 nm with high brightness number being easily created through optical brightening agents (OBAs). The second is that different CMYK combinations can be found that create the identical CIELAB values (under a specified standard illuminant) while being strongly different under UV illumination.

The second assumption is theoretically true, but suffers from a large number of problems in reality. The first problem is that the theoretical solution exists in a continuous space, but when printing, a sparse discrete system is employed. There are limited patterns that match exactly under standard light (e.g., a standard illumination value such as D65) while being strongly different under UV light. Secondly, the color match has to be reasonably stable under printer variations and thus even fewer patterns qualify as matching patterns. Additionally, these available colors are highly clustered in a small region of color space. This is in part because UV modulation is achieved by area coverage and high area coverage colors restrict the modulation depth.

Accordingly, there is an unmet need for systems and/or methods that combine substrate fluorescence watermarking techniques with metamer color pair generation and adaptive halftoning to generate fluorescent watermarks in background images and to facilitate overcoming the aforementioned deficiencies.

### BRIEF DESCRIPTION

In accordance with various aspects described herein, systems and methods are described that facilitate printing UV-fluorescent watermarks in background images to improve document security. For example, a method of generating an ultraviolet (UV) watermark in a background image comprises using a set of metameric color pairs containing UV-active and UV-dull color pairs, and generating an electronic continuous-tone background image for a document, generating a binary watermark mask for the background image, and the watermark mask is used to separate the background image into two regions: a UV-active region and a UV-dull region. The method further includes executing an adaptive halftoning algorithm for the background image, choosing the appropriate color from the metameric color pair based on the UV-active and UV-dull regions.

According to another aspect, a counterfeit-deterrent document printing system comprises an image generator that generates a printed version of a continuous-tone background image for a document, and a processor that analyzes the continuous-tone background image, generates a binary watermark mask for the background image by assigning a binary value to each pixel in the background image to separate the background image into two regions: a UV-active region and UV-dull region, wherein pixels in the background image corresponding to the binary value of 1 in the watermark mask are defined as UV-active region, and pixels in the background image corresponding to the binary value of 0 in the watermark mask are defined as UV-dull region. The processor executes an adaptive halftoning algorithm using UV-active colors in the UV-active region of the continuous-tone background image to generate a halftone image, and using UV-dull colors in the UV-dull region of the continuous-tone background image to generate a halftone image. The system further comprises a printer that prints a watermarked background image comprising the a UV-active and UV-dull region.

According to another aspect, an apparatus for generating a security watermark in a background image on a document comprises means for generating an electronic continuous-tone background image for a document, and means for generating a binary watermark mask for the background image, wherein the watermark mask is used to separate the background image into two regions: a UV-active region and a UV-dull region. The apparatus further comprises means for executing a metamer color pair generation algorithm that generates UV-active and UV-dull color pairs, and means for generating a halftone UV-active image in the UV-active region, and generating a halftone UV-dull image in the UV-dull region. Additionally, the apparatus comprises means for generating a watermarked background image by combining the halftone image in the UV-active region and the halftone image in the UV-dull region, and means for printing the watermarked background image on a document.

### BRIEF DESCRIPTION OF THE DRAWINGS

FIG. 1 illustrates an anti-counterfeit printing system that includes a processor that executes, and a memory that stores, machine-executable instructions for performing the various acts and/or functions described herein to generate UV-fluorescence encoded background images on documents.

FIG. 2 illustrates a personal check including a “light” background image, wherein textual information is not considered part of the background image.

FIG. 3 shows a conceptual set of ten Lab (or L*a*b*) colors that have a high UV activity.

FIGS. 4A and 4B illustrate a metamer color pair including a UV-active color or pattern and a UV-dull color or pattern.

FIG. 5 shows the original UV-active colors with their corresponding UV-dull color patterns.

FIG. 6 illustrates a rendered color background image with two separate output color sets as a function of the UV response of an individual set.

FIG. 7 illustrates and enlarged section of the image of FIG. 6.

FIG. 8 shows an enlarged section of the image under UV light.

FIG. 9 illustrates a method of generating security watermarks in a background image using non-UV fluorescent ink(s) and an adaptive halftoning technique.

### DETAILED DESCRIPTION

In accordance with various features described herein, systems and methods are described that facilitate generating a UV fluorescent image using non-UV fluorescent ink(s) within a background image through the use of adaptive halftoning into disjoint output structures. In this context, color control and rendering are combined into a single step.

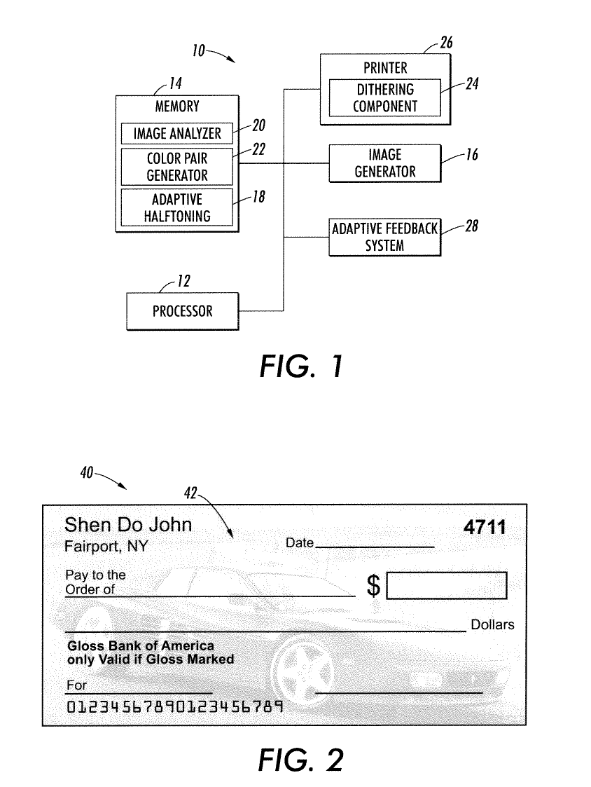

With reference to FIG. 1, an anti-counterfeit printing system 10 includes a processor 12 that executes, and a memory 14 that stores, machine-executable instructions for performing the various acts and/or functions described herein to generate UV-fluorescence encoded background images on documents (e.g., currency, personal checks, or any other type of document for which authentication is desirable). An image generator 16 generates a continuous-tone background image for printing on a document (e.g., a check, a ticket, currency, or some other suitable document). This continuous-tone background image is rendered using a set of available print colors, where the set consists of one subset of UV-active print output colors and one subset of UV-dull print output colors, where the subsets of UV-active and UV-dull print output colors cover substantially the same subspace of the entire printer color space, where the subspace is defined by that portion of the printer gamut that has sufficient metameric color pairs to create a UV signal. The image generator then generates a binary watermark mask for the background image, wherein the watermark mask is used to separate the background image into two regions: a UV-active region and a UV-dull region. For example, pixels associated with UV-active regions of the background image are assigned a binary mask value of 1, and pixels associated with UV-dull regions of the background image are assigned a binary mask value of 0. Alternatively, UV-active pixels are assigned the 0-value, and UV-dull pixels are assigned the 1-value. In either case, the pixels in both the UV-dull and UV-active regions of the fluorescent image are distinguished from one another.

In one embodiment, the image generator generates a UV-active region for the background image using UV “active” colors (e.g., colors that are highly visible under UV light), which includes all pixels identified as UV-active pixels in the watermark mask and is perceptible to the human eye under UV light, assuming that all pixels not identified as UV-active are considered UV-dull. The processor 12 uses a metameric color pair set to create a print-ready image from the input image. The metameric color pair set has been created by the metamer color pair generator.

Metamer color pairs can be generated using known technologies described in U.S. application Ser. No. 11/754,733 and No. 11/754,702. Once determined, the image generator 16 uses the identified complementary colors to generate a UV-dull region of the background image. The processor executes the adaptive halftoning algorithm on the background image. At this point, a non-adaptive method might still be used, since no statement has been made about the UV-active and UV-dull subsets of the metameric color pairs. However, since the metameric color pair sets will be inherently sparse, an adaptive halftoning algorithm, such as Error Diffusion or one of its variants is the preferred embodiment for the halftoning step.

In one embodiment, the UV-active and UV-dull color pairs are approximate metamers of each other. In another embodiment, one or more of a UV-active color and a UV-dull color is left unpaired. For instance, there may be 9 color pairs, each with a UV-active and UV-dull metamer (identical or approximate), and a 10^{th} color (e.g., UV-active or dull) may be unpaired. In another embodiment, more than one color is unpaired.

A dithering component 24 in a printer is then employed to halftone the UV-active and UV-dull colors into an image that is printed by the printer. In this manner, a UV fluorescent image with a watermark therein is generated for a document to permit document authentication and to prevent counterfeiting of such documents. Under normal light (e.g., white light or the like), the background image is visible while the watermark is not, since the UV-active and UV-dull color pairs appear the same in normal lighting conditions. However, under UV light, the UV-dull watermark region appears more dull (e.g., less bright) than the UV-active region of the background image. It will be appreciated that the UV-dull and UV-active regions of the fluorescent background image may be alternated, such that the UV-active region corresponds to the watermark and the UV-dull region corresponds to the rest of the fluorescent background image. Additionally, it will be appreciated that more than one UV-active and/or UV-dull region may be generated, in a case wherein multiple watermarks are employed, for instance.

In one embodiment, the set of metamer color pairs would have an equal number of UV-dull and UV-active colors and these color pairs would be ideal metamers of each other. Here and in the following the term “metamer” is used to describe the situation where an identical signal can be obtained using different physical quantities. The most common metameric situation is the use of different materials to create a color image. For example, a real object, a print of the same object, a computer monitor representation of the same object, or a painting of the same object will all appear to have the identical color to a human observer, despite the fact that the actual physical color, i.e.: the physical spectrum, might be very different.

In printing system, another variant of metameric representation appears. For full color images, the human visual system incorporates (to sufficient description) three independent color channels, normally referred to as short, medium and long wavelength. Thus it is possible to represent a full color image with three independent components, for example red, green, and blue on a computer monitor. Standard printing systems, on the other hand, commonly use four (or more) colorants, for example cyan, magenta, yellow, and black. It is clear that multiple colorant combinations can create the same color to a human, or in mathematical terms, the system of four components is not completely determined for a unique solution. It is understood that colorant systems have degenerated points were only one colorant combination would create the desired color—for example, solid yellow can only be obtained by using the yellow colorant.

It is understood that the metameric case of four colorants and three visual channels is only one implementation. Using more than four colorants, like six for example adding green and orange or any other colorant number larger than three also exhibits metamerism.

It is also understood that fewer than four colorants can be used if the part of the color space that is to be represented is reduced. For example, black and white images are correctly represented by a single component and a single component black and white printer thus does not exhibit metamerism. A theoretical black and white printer can be conceptualized using two colorants, e.g.: cyan and red. In this scenario, metamer color pairs are created. Additionally, colorants like white or clear which are often not talked about as colorants are also useful in the present invention, since again, the number of possible colorant combinations for a specific required color is larger than one and thus metameric.

It is further understood that there has to be a distinction in the UV response of the involved materials, e.g., the paper has high UV-activity and at least one of the toners has a low UV-activity.

The most common scenario in current printing systems is that four colorants are used and that the majority of the colorants have no relevant UV activity. Accordingly, the following description is limited to this case, keeping in mind the above mentioned scenarios.

In one embodiment, artifacts caused by the disjoint output color sets (e.g., by the UV-active colors and the UV-dull colors) are compensated by an adaptive feedback system 28 that iteratively adjusts color pairs until artifacts are reduced to a predetermined level or are eliminated.

In another embodiment, the metamer color pairs (e.g., UV-active and UV-dull color pairs) have identical L*a*b* values, but UV-active colors have a higher UV luminescence than UV-dull colors. Lab color space is a color-opponent space in which L denotes lightness, and a and b denote the color-opponent dimensions as a function of nonlinearly-compressed CIE XYZ color space coordinates. Lab is often used as an informal abbreviation for the CIE 1976 (L*, a*, b*) color space (also called CIELAB, whose coordinates are L*, a*, and b*). Lab and L*a*b* color spaces are related in purpose, but differ in implementation.

The disjoint UV-active and UV-dull subspaces can be understood by considering the finite capabilities of any printing process. In an idealized system, an equal number of UV-active and UV-dull colors are created, and the pairs are true metamers, meaning that they are indistinguishable to the human eye, despite being created with different colorant combinations. In real world scenarios, this ideal visual match (ideal metamer) is often not achievable due to finite resolutions and/or other real limitations. One important aspect of the present innovation is that a UV signal can still be obtained if the UV-active and UV-dull color subset differ in number and actual color values can be obtained through the use of the adaptive halftoning into the two disjoint sets.

The term disjoint sets will be used hereinafter to indicate that the actual colors of the metameric color pairs are only approximately metameric and that not every color has to posses a unique matching pair color. However, it is assumed that the two color subsets span substantially overlapping regions of the achievable color space.

The difference in UV-active and UV-dull colors is a function of the amount of toner area coverage. For instance, although the UV-active and UV-dull color pair may exhibit the same color under visible light, under UV light the UV-active color (which contains less toner area coverage than a UV-dull pixel having the same L*a*b* value) appears lighter than a corresponding UV-dull color.

With regard to the adaptive halftoning algorithm(s) 18 executed by the processor, adaptive halftoning (e.g., error diffusion) is a type of halftoning in which the quantization residual is distributed to neighboring pixels which have not yet been processed. Its main use is to convert a multi-level image into a few-level image, though it has other applications. Here, the few levels might be binary or one of a set or available discrete colors, or one of a set of discrete output levels. Unlike many other halftoning methods, error diffusion and its known variants are classified as an “area” operation, because the results of the algorithm at one location influence the results of the algorithm at other locations. Accordingly, the processor 18 employs a buffering technique to store results of the algorithm and/or performs parallel processing techniques. In this manner, the error diffusion algorithm is employed to enhance edges in background image and/or the UV masks.

FIG. 2 illustrates a personal check 40 including a “light” background image 42, wherein textual information is not considered part of the background image. The background image 42 is an example of the type of image that is generated and/or employed by the systems and methods described herein, wherein UV-active and UV-dull color pairs are employed to generate a UV-fluorescent watermark in the background image that is not visible in regular light (e.g., light in the visible spectrum). Such background images are used as a form of security mechanism to authenticate documents such as personal checks, event tickets, currency, and the like. Having defined the images to be encoded, the following figures and related description address generating matching color pairs in typical background images to permit generation go the UV fluorescent watermarks.

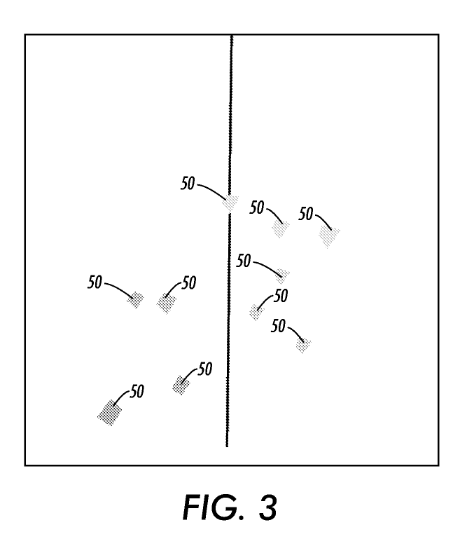

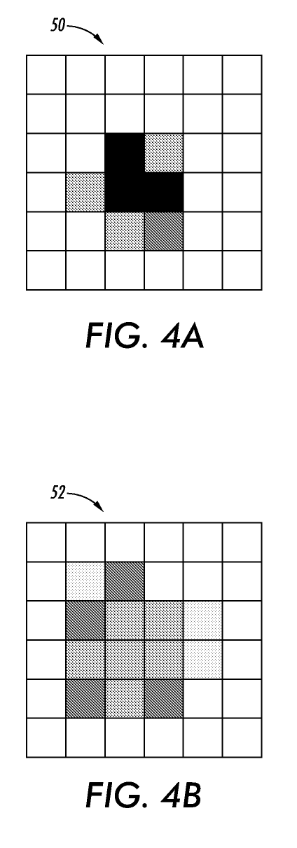

FIG. 3 shows a conceptual set of ten Lab (or L*a*b*) colors 50 that have a high UV activity. There are several issues to be considered when employing UV “colors.” For instance, in fluorescent rendering, it is often not sufficient to create two metameric CMYK quadruplets and render them using standard halftoning algorithms. Doing so would create the “correct” color only on an average basis over the halftoning rosettes. Therefore, to generate a stronger signal, the described fluorescent rendering technique directly creates a “color/pattern” combination that locks the rendering of a specific color over a cell (e.g., 16×16 pixels or some other predetermined suitable size), where all four separations are contained. This cell then can be considered one of the available few levels for adaptive halftoning, or a subset of the cell might be considered one of the available few levels of the adaptive halftoning. FIGS. 4A and 4B illustrate a color pair including a UV-active color or pattern 50 and a UV-dull color or pattern 52. UV-active color comprises black, cyan and magenta, while UV-dull color comprises cyan, magenta and yellow. In this illustrative example, the cell size is 6×6. The UV-active color 50 has less toner area coverage than the corresponding UV-dull color 52, so it will appear lighter under UV light. These two colors will exhibit the same color appearance to the human eye under visible light. It is understood that the patterns in FIG. 4 are idealized and that actual metameric color pairs are created through calibration and will in general deviate from this illustrative pattern.

Within a convex hull or set of these “UV-active” colors, an input image is rendered. However, for UV image watermarking, a corresponding set of “UV-dull” colors (e.g., colors having identical CIELAB value, but different UV characteristics) are used.

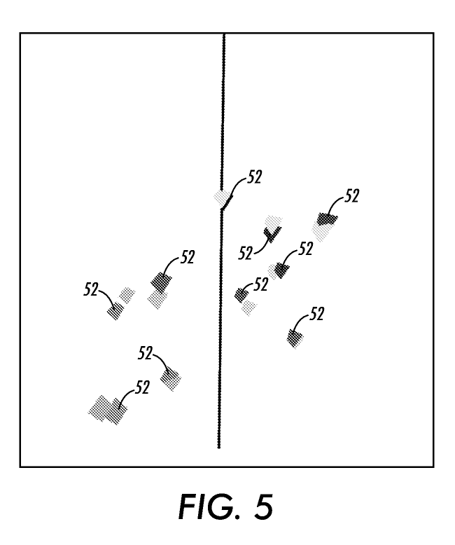

FIG. 5 shows the original UV-active colors 50 with their corresponding UV-dull colors 52. The corresponding UV-dull colors 52 are generated using known techniques described in U.S. application Ser. No. 11/754,733 and No. 11/754,702. FIG. 5 thus shows the conceptual best-match UV-dull colors 52 added to the active UV colors 50 of FIG. 3.

At this point, a modified vector error diffusion algorithm is implemented as an exemplar of an adaptive halftoning process. While some error diffusion techniques replace individual pixels one at a time, vector error diffusion techniques replace blocks of pixels (e.g., 16×16 blocks or the like) at a time. In this algorithm, the available output colors are no longer static, but a function of a UV-activity signal. For all image pixels that fall into a given mask area, the colors from the UV-active color set are selected. For all other pixels, the colors are selected from the UV-dull color set. Error feedback provided by the error diffusion algorithm is then used to compensate for the difference in available output states.

In a UV watermarking scenario, the additional problem appears that the two output sets may show different instabilities (instabilities are mainly determined by the distribution of output states and different output sets will thus potentially show different behavior). Such instability can be compensated using known compensation methods.

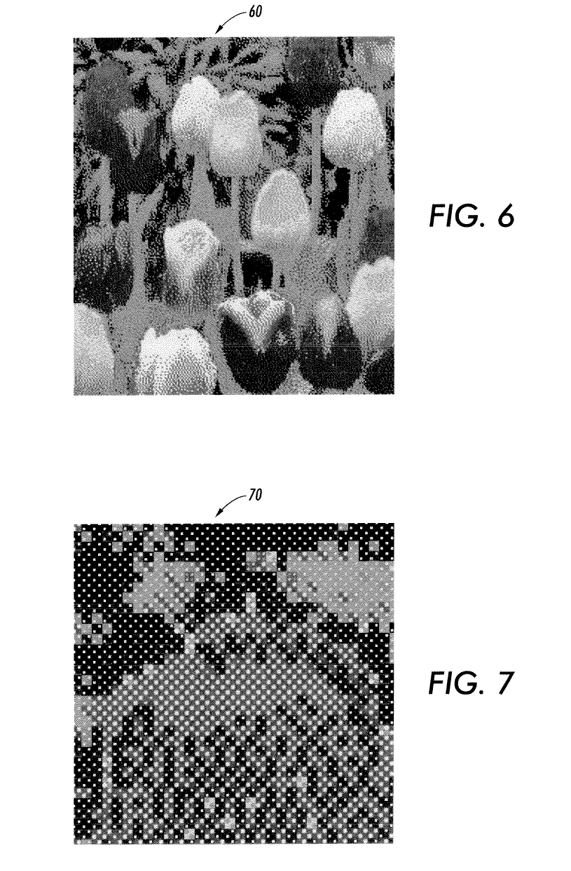

FIG. 6 illustrates a rendered color background image with two separate output color sets as a function of the UV response of an individual set (e.g., the UV-active set and UV-dull set).

FIG. 7 illustrates an enlarged section 70 of the image 60 of FIG. 6. It will be observed that the rendering of the background image is not done in “simple” colors, but into specific color patterns that are designed to create specific UV responses. FIG. 7 shows the actual print data into which patch calibration is already embedded to mitigate a need for a standard color management (CMM). That is, rather than rendering into “colors,” the modified error diffusion algorithm renders into “patterns” that have associated color and UV attributes.

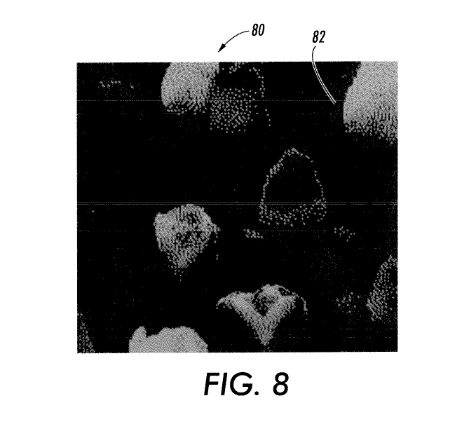

FIG. 8 shows an enlarged section 80 of the image under UV light. In this case a simple “X” 82 was generated as the watermark. It should be noted that in addition to constraining the background images to be “light,” it may also be desirable to use “simple” UV watermarks. This can be understood when considering that the distinction of the two color sets is based on “high UV” (e.g., active UV) and “low UV” (e.g., dull UV) responses without consideration for the absolute UV response, according to one aspect. Thus, in some parts of the image, the low UV response may actually be higher (in absolute terms) than the high UV response in other parts of the image. In any case, the UV watermark is solely based on local differentiation between the UV responses and not necessarily on the global UV differentiation.

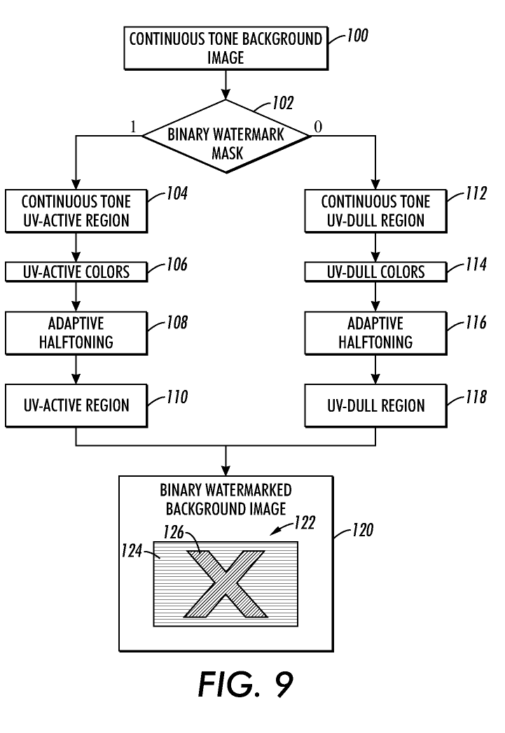

FIG. 9 illustrates a method of generating security watermarks in a background image using non-UV fluorescent ink(s) and adaptive halftoning technique. At 100, an electronic continuous-tone background image is generated for embedding the watermark. At 102, a binary watermark mask is generated for the background image, wherein the watermark mask is used to separate the background image into two regions: a UV-active region and a UV-dull region. At 104, a continuous-tone UV-active region is identified, which comprises UV-active pixels. At 106, a metamer color pair generation algorithm is executed to generate UV-active and UV-dull color pairs, and the UV-active colors are employed in the UV-active region (e.g., a watermark, such as the “X” of FIG. 8) that overlays the background image. At 108, an adaptive halftoning algorithm is applied in the UV-active region of the continuous-tone background image to generate a halftone image in the UV-active region. At 110, the halftone UV-active image is generated, comprising all pixels in the UV-active region.

Meanwhile, at 112, a continuous-tone UV-dull region is identified, which comprises UV-dull pixels. At 114, the UV-dull colors are generated by the metamer color pair generation algorithm and employed in the UV-dull region. At 116, the adaptive halftoning algorithm is applied to the UV-dull region of the continuous-tone background image to generate a halftone image in the UV-dull region. At 118, the halftone UV-dull region is generated, comprising all pixels in the UV-dull region.

It should be noted that the adaptive halftonings of 108 and 116 may be used independently, or they may use the same state information in the adaptive halftoning and thus implicitly communicate with each other. Also, the adaptive nature, i.e.: the error feedback in the exemplary Error Diffusion, might be modified to be undercompensated, in accordance with the known variants of Error Diffusion.

At 120, a watermarked background image 122 is generated, which includes combining the binary halftone image in the UV-active region and the binary halftone image in the UV-dull region.

According to one aspect, pixels in the continuous-tone background image correspond to a binary value of 1 in the watermark mask and are defined as UV-active region, and pixels in the continuous-tone background image corresponding to a binary value of 0 in the watermark mask are defined as UV-dull region.

In another aspect, the UV-active and UV-dull color pairs each have a UV-active color that exhibits a first UV response and a corresponding UV-dull color that exhibits a second UV response that is lower than the first UV response, and the UV-active and UV-dull colors of a given color pair exhibit the same color value when exposed to light in the visible spectrum.

Additionally, a watermarked image is generated by combining a halftone image in the UV-active region and a halftone image in the UV-dull region. The adaptive halftoning algorithm is executed using UV-active colors in the UV-active region of the continuous-tone background image to generate the binary halftone image in the UV-active region. The adaptive halftoning algorithm using UV-dull colors in the UV-dull region of the continuous-tone background image to generate the binary halftone UV-dull image in the UV-dull region.

The halftone in the UV-active region creates a state for the adaptive halftoning that might be maintained when the output switches to the UV-dull region and vice versa. In this way, the halftoning of the two regions optionally becomes interlinked. This cross adaptation might be used additionally to the adaptive nature of the halftoning within one of the regions. This interaction might be dampened or undercompensated as is well known in the field of error diffusion.

In one embodiment, the adaptive halftoning algorithm concurrently adjusts two or more pixels at a time. In another embodiment, the adaptive halftoning algorithm concurrently adjusts all pixels in a 16×16 cell of pixels.

It will be appreciated that the UV-active and UV-dull pixels may be reversed, in accordance with various aspects. For instance, the UV-fluorescent background image may comprise UV-active colors, and the watermark image may comprise UV-dull colors. Additionally, the binary values of the watermark mask assigned to the UV-active and UV-dull pixels may be reversed in some embodiments.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of generating an ultraviolet (UV) watermark in a background image, comprising:
generating an electronic continuous-tone background image for a document;
generating a binary watermark mask for the background image, wherein the watermark mask is used to separate the background image into two regions: a UV-active region and a UV-dull region,
executing a metamer color pair generation algorithm that generates UV-active and UV-dull color pairs;
generating a halftone UV-active image in the UV-active region, and generating a halftone UV-dull image in the UV-dull region;
generating a watermarked background image by combining the halftone image in the UV-active region and the halftone image in the UV-dull region; and
printing the watermarked background image on a document.

2. The method of claim 1, wherein pixels in the continuous-tone background image corresponding to a binary value of 1 in the watermark mask are defined as UV-active region and pixels in the continuous-tone background image corresponding to a binary value of 0 in the watermark mask are defined as UV-dull region.

3. The method of claim 1, wherein the UV-active and UV-dull color pairs each have a UV-active color that exhibits a first UV response and a corresponding UV-dull color that exhibits a second UV response that is lower than the first UV response, and wherein the UV-active and UV-dull colors of a given color pair exhibit the same color value when exposed to light in the visible spectrum.

4. The method of claim 1, further comprising executing the adaptive halftoning algorithm using UV-active colors in the UV-active region of the continuous-tone background image to generate the halftone UV-active image.

5. The method of claim 1, further comprising executing the adaptive halftoning algorithm using UV-dull colors in the UV-dull region of the continuous-tone background image to generate the halftone UV-dull image.

6. The method of claim 1, wherein respective corresponding UV-dull colors and UV-active colors share the same L*a*b* color values while exhibiting different UV luminescence characteristics that are discernible under UV light.

7. The method of claim 1, wherein the adaptive halftoning algorithm concurrently adjusts two or more pixels at a time.

8. The method of claim 7, wherein the adaptive halftoning algorithm concurrently adjusts all pixels in a 16×16 cell of pixels.

9. The method of claim 1, wherein the UV-active and UV-dull color pairs are approximate metamers of each other.

10. The method of claim 1, wherein one or more of a UV-active color and a UV-dull color is left unpaired.

11. A counterfeit-deterrent document printing system, comprising:
an image generator that generates a continuous-tone background image for a document;
a processor that executes computer executable instructions for:
generating an electronic continuous-tone background image for a document;
generating a binary watermark mask for the background image, wherein the watermark mask is used to separate the background image into two regions: a UV-active region and a UV-dull region,
performing a metamer color pair generation algorithm that generates UV-active and UV-dull color pairs;
generating a halftone UV-active image in the UV-active region, and generating a halftone UV-dull image in the UV-dull region;
generating a watermarked background image by combining the halftone image in the UV-active region and the halftone image in the UV-dull region; and
a printer that prints watermarked background image on a document.

12. The system of claim 11, wherein the processor executes an adaptive halftoning algorithm on the UV-active region of the continuous-tone background image to generate the halftone UV-active image in the UV-active region.

13. The system of claim 11, wherein the processor executes the adaptive halftoning algorithm on the UV-dull region of the continuous-tone to generate the halftone UV-dull image in the UV-dull region.

14. The system of claim 11, wherein the processor executes the metamer color pair generation algorithm to identify UV-dull colors corresponding to UV-active colors, wherein the UV-dull color assigned to a watermark pixel has a same L*a*b* values as, but lower UV fluorescence than, its corresponding UV-active color.

15. The system of claim 11, wherein the printer comprises a dithering component that prints the combined halftone UV-active image and halftone UV-dull image on a printing substrate.

16. An apparatus for generating a security watermark in a background image on a document, comprising:
means for generating an electronic continuous-tone background image for a document;
means for generating a binary watermark mask for the background image, wherein the watermark mask is used to separate the background image into two regions: a UV-active region and a UV-dull region,
means for executing a metamer color pair generation algorithm that generates UV-active and UV-dull color pairs;
means for generating a halftone UV-active image in the UV-active region, and generating a halftone UV-dull image in the UV-dull region;
means for generating a watermarked background image by combining the halftone image in the UV-active region and the halftone image in the UV-dull region; and
means for printing the watermarked background image on a document.

17. The apparatus of claim 16, wherein pixels in the continuous-tone background image corresponding to a binary value of 1 in the watermark mask are defined as UV-active region and pixels in the continuous-tone background image corresponding to a binary value of 0 in the watermark mask are defined as UV-dull region.

18. The apparatus of claim 16, wherein the UV-active and UV-dull color pairs each have a UV-active color that exhibits a first UV response and a corresponding UV-dull color that exhibits a second UV response that is lower than the first UV response, and wherein the UV-active and UV-dull color pair of a given color exhibit the same color value when exposed to light in the visible spectrum.

19. The method of claim 16, further comprising a means for generating a watermarked image that executes an adaptive halftoning algorithm using UV-active colors in the UV-active region of the continuous-tone background image to generate the halftone UV-active image, and using UV-dull colors in the UV-dull region of the continuous-tone background image to generate the halftone UV-dull image.

20. The apparatus of claim 16, wherein the adaptive halftoning algorithm concurrently adjusts two or more pixels at a time.

21. The apparatus of claim 20, wherein the adaptive halftoning algorithm concurrently adjusts all pixels in a 16×16 cell of pixels.
